(19) United States
(12) Patent Application Publication
(10) Pub. No.: US 2021/0008774 A1
(43) Pub. Date: Jan. 14, 2021

(54) Method for the Automatic Process Monitoring and Process Diagnosis of a Piece-Based Process (batch production), in Particular an Injection-Moulding Process, and Machine That Performs the Process or Set of Machines that Performs the Process

(71) Applicant: KRAUSSMAFFEI TECHNOLOGIES GMBH, München (DE)

(72) Inventors: Stefan KRUPPA, München (DE); Stefan MOSER, Hallbergmoos (DE); Matthias BUSL, Karlsfeld (DE); Reinhard SCHIFFERS, Duisburg (DE)

(21) Appl. No.: 16/978,276

(22) PCT Filed: Mar. 26, 2019
(86) PCT No.: PCT/EP2019/057524

§ 371 Date: Sep. 4, 2020

(30) Foreign Application Priority Data
Mar. 27, 2018 (DE) 10 2018 107 233.3

(51) Int. Cl. B29C 45/76; G05B 19/042; G05B 23/02

(52) U.S. Cl. CPC B29C 45/766; G05B 19/042; G05B 23/0218; B29C 2945/76163; G05B 2219/2624; B29C 2945/76949; B29C 45/768

(57) ABSTRACT

A method for the automatic process monitoring and/or process diagnosis of a piece-based process, in particular a production process, in particular an injection-molding process, including the steps: a) performing an automated reference finding in order to obtain reference values (r₁ . . . rₙ) from values (x₀ . . . xⱼ) of at least one process variable; b) performing an anomaly detection on the basis of the reference values (r₁ . . . rₙ) found in step (a); c) performing an automated cause analysis and/or an automated fault diagnosis on the basis of a qualitative model of process relationships and/or on the basis of dependencies of various process variables on each other.

The invention relates to a method for the automatic process monitoring and for the diagnosis of a piece-based process and a machine that performs the process, in particular an injection-moulding machine, or a set of machines that performs the process.

A process monitoring and/or a process diagnosis is generally based on fixed limits which must firstly be established manually. This means that a process variable or an index has an upper and a lower threshold which, for example, must be determined based on experience of the operating personnel and in particular must be set manually in the control or in an operating data acquisition system. Furthermore, it is known to make an exceeding of a threshold able to be detected in multiple stages, for example by means of a warning upstream of the alarm.

Proceeding from this, the stability of the process or the process capability, i.e. the executability of the process is evaluated and, in the case of departing from the desired process, e.g. on exceeding or falling below the upper or lower threshold, measures are initiated which e.g. can comprise a reject sorting and an alarming.

From the specialist publication of 14.07.2015 with the title ‘Priamus FILL CONTROL 1.13 Release Hinweise der Priamus System Technologies AG, Schaffhausen, Schweiz’, a concept is presented for a process monitoring by means of a so-called Q button of the company Priamus System Technologies AG in 8200 Schaffhausen, Switzerland. In this technology, the threshold determination of the upper and/or lower threshold is executed semi-automatically by means of a so-called Q button. This is an operating device which automatically sets thresholds on the basis of “six sigma values”, which guarantee an appropriate setting for the monitoring in an optimized process.

Furthermore, it is known from the Western Electric Company (1956), Statistical Quality Control handbook; 1 ed., Indianapolis, Ind.: Western Electric Co., to determine from the reference the standard deviation and, based thereon, to generate with fixed rules concerning alarms parameters or control variables.

All the procedures from the prior art have in common the fact that they generate singular alarms or other actions for each exceeding of tolerance of a specific parameter, without a possible interaction of the individual parameters/exceeding of tolerance being taken into consideration. In other words, no causal connection is made between the threshold violations, so that an interference variable which may possibly be present, which e.g. can have effects on various values, can not be reliably detected.

Methods on the basis of machine learning are able to detect anomalies in an automated manner and even to make diagnoses. However, these require data in advance, which reflect the corresponding interferences and the associated causes. Therefore, they are only able to make diagnoses which are known or respectively have already occurred and, if applicable, to repeat them. In addition, it is difficult to set up generally valid models through these methods, because they can not differentiate between specific and generally valid correlations.

Such methods are already used in order to predict quality (cf. U.S. Pat. No. 7,216,005 B2). In such methods, however, the algorithm must firstly be taught specifically with respect to a process. The proposed methods are therefore not teachable and executable independently.

Furthermore, expert systems, and diagnosis methods based on qualitative models for example under the term “model-based diagnosis” are known (cf. R. Reiter, A theory of diagnosis from first principles, Artificial Intelligence 32 (1) (1987) 57-95).

The prior art outlined above has a number of disadvantages. Owing to the manual establishing of the thresholds, two conditions must exist for an effective monitoring:
1. A threshold must be established and
2. The monitoring must be applied.

Thresholds can be determined via tests and/or can be derived automatically from these. Nevertheless, the test period and/or the data for this must be communicated explicitly to the program which undertakes the machine control/process control.

In the example of an injection-moulding process, the following is explained. With the approximately 100 process variables of a modern injection-moulding machine (cf. actual value cycles), in practice thresholds are established only for a few process variables. Likewise, the monitoring possibilities which are integrated in the machine and in external systems (MES) are not always utilized, because also the thresholds can change or respectively must change depending on the machine which is used, environmental influences and material/material characteristics for a process, in order to achieve a consistent quality monitoring.

In consequence of the necessary extensive workload resulting herefrom for keeping the thresholds current, a plurality of process variables out of the approximately 100 process variables mentioned above mostly remain unmonitored in practice.

Only the most important functions are updated to the effect that thresholds adapted to the instantaneous environmental conditions are inputted manually.

Therefore, the control potential, in particular with regard to a theoretically possible threshold monitoring, remains unused over wide areas, because a full utilization of the potential means a very great effort in updating and maintenance effort by the operating personnel.

A further disadvantage is that from the information as to which instances of exceeding tolerance occur or in which way the tolerances are exceeded (e.g. once, permanently, insidiously and/or becoming increasingly more intensive and/or decreasingly, etc.) no further automatic conclusions can be drawn from this information. Thereby, it can therefore be entirely possible that several instances of exceeding tolerance occur simultaneously which have a common clear cause, without this being named, detected and therefore analysed in a targeted manner.

Rather, it lies in the experience of the operator, with a particular characteristic combination of instances of exceeding tolerance of individual values of process variables, to detect a possible common cause and to remedy this on the basis of his technical knowledge.

It is therefore an object of the invention to prevent and/or at least mitigate the above-mentioned disadvantages of the prior art. In particular, a fully automatic process monitoring and process diagnosis, in particular for a piece-based process, which can be in particular an injection-moulding process, is to be indicated, wherein the method is to be able to establish reference values and thresholds for process variables in an automated and in particular self-learning manner, in order to detect causes from instances of exceeding threshold and anomaly evaluations, to at least report these, if applicable even suppress these and draw conclusions regarding possibly appropriate new references or respectively thresholds.

This problem is solved by a method having the features of Claim 1. Advantageous embodiments are indicated in the subclaims.

A method according to the invention for the automated process monitoring and/or process diagnosis of a piece-based process, in particular of a production process of in particular identical parts, in particular of an injection-moulding process, has the steps:
a) Performing an automated reference finding in order to obtain reference values r₁ . . . rₙ from values x₀ . . . xⱼ of at least one process variable;
b) Performing an anomaly detection on the basis of the reference values r₁ . . . rₙ found in step (a) ;
c) Performing an automated cause analysis and/or an automated fault diagnosis on a basis of a qualitative model of process relationships and/or on the basis of dependencies of various process variables on each other.

With the method according to the invention, despite a plurality of possible anomalies occurring, these anomalies can be successfully sorted and brought into a convenient, clear representation for the operator, so that the operator also receives a preferably clear indication of cause on the basis of a plurality of anomalies, by means of which he can remedy an intrusive cause, therefore e.g. a process interference variable or another interference of the process.

Furthermore, the operator is relieved from establishing thresholds manually for different process variables, even when environmental conditions or such like possibly change. The method according to the invention can deal with this automatically and can therefore provide for a further automated process improvement and therefore an increase in quality of the produced pieces, e.g. injection moulded parts.

Because corresponding thresholds are present in an automated manner for a plurality of process variables, the method according to the invention can also bring about an automated monitoring of all process variables and, through a plurality of these monitored process variables, can make available an improved cause analysis and cause indication in an automated manner.

In a preferred embodiment of the method according to the invention, a result of the cause analysis and/or of the fault diagnosis is outputted at an output device for an operator, or a result of the cause analysis/fault diagnosis is further processed in an automated manner. This can take place e.g. in that the result of the cause analysis is made available to a machine control and/or to a control of a set of machines and/or to a control for influencing a machine environment, e.g. a factory hall, e.g. its heating/air-conditioning or suchlike. Hereby, it is successful either to make it particularly apparent to the operator which causes for a particular anomaly are present, or an automated averting of these anomalies can be successfully achieved when for example a machine control or a machine hall control or a control for a set of machines react accordingly to results of the cause analysis.

In a preferred embodiment of the method according to the invention, step a) can comprise at least one or several of the sub-steps listed below:
a1) Evaluation of process values x₀ . . . xⱼ of process variables over several process cycles with regard to their suitability for use as reference through the calculation of evaluation indices b₁ . . . bᵢ and application of established rules, wherein as evaluation indices b₁ . . . bᵢ for example the change trend of the values x₀ . . . xⱼ of the process variables and/or fluctuations of the process variables are used or
a2) as reference of the automatic process monitoring and/or automatic process diagnosis automatically determined reference values r₁ . . . rₙ are used, which e.g. reflect the “natural” noise or uncertainty of the process variable, which each process variable has owing to environmental conditions and/or sensor noise or
a3) when the provisional reference values r*₁ . . . r*ₙ formed from the process values x₀ . . . xⱼ of process variables on the basis of criteria and rules are better than the currently best found reference values r₁ . . . rₙ, these are set up as new best found reference values r₁ . . . rₙ or
a4) the reference values r₁ . . . rₙ from step a3) are used in order to automatically detect, to evaluate and/or if applicable to mark e.g. jumps, increases, outliers as anomalies or
a5) wherein the automatic reference, i.e. the reference values r₁ . . . rₙ at predetermined events is obligatorily newly formed, wherein such predetermined events can be, for example, a longer standstill of the machine carrying out the process, or a change of tool.

In a further preferred embodiment of the method according to the invention, each process variable is assigned a reference generator for the formation of reference values r₁ . . . rₙ, which is preferably equipped by the manufacturer with an initial reference, from which then the development of further future references, i.e. reference values r₁ . . . rₙ can take place. The initial reference represents here a first current reference with the reference values r₁ . . . rₙ, which is able to be modified with the method according to the invention, in particular in step a).

In a further preferred embodiment of the method according to the invention, a reference consists of several values r₁ . . . rₙ, wherein the values r₁ . . . rₙ reflect characteristics of a value progression of values x₀ . . . xⱼ of a process variable, e.g. the standard deviation or the median of the values.

A further embodiment of the method according to the invention is characterized in that during the sequence of the process the reference values is adapted to the value progression of the values x₀ . . . xⱼ of the process variable which is determined by measurement, wherein a window of j values is taken into consideration for this.

In a further embodiment, from the j values of the process variable provisional reference values rᵢ* . . . rₙ* and evaluation numbers b₁ . . . bᵢ are formed, wherein the evaluation numbers b₁ . . . bᵢ can be the increase or the curve of the j values and/or of the value progression over time.

It can be furthermore advantageous to establish from the evaluation numbers b₁ . . . bᵢ of the current reference (values r₁ . . . rₙ) and the provisional reference (values r₁* . . . rₙ*) by means of predetermined rules whether the current reference r₁ . . . rₙ is maintained or the provisional reference rᵢ* . . . rₙ* in future is used as new current reference r₁ . . . rₙ and therefore the provisional reference rᵢ* . . . rₙ* replaces the hitherto current reference r₁ . . . rₙ.

It is expedient that for each process variable an anomaly detection is provided, which uses current reference values r₁ . . . rₙ and/or past values x₁ . . . xⱼ of the process variable, in order to establish an extraordinary value, i.e. an anomaly, or assigns a probability of anomaly to an extraordinary value.

Furthermore, it is preferred to characterize or evaluate as an anomaly a value which e.g. lies more than three reference standard deviations away from the reference mean value, e.g. by indication of the deviations from the reference mean value in multiples of the reference standard deviation. This embodiment is not restricted solely to triple the reference standard deviation. If applicable, depending on the value under consideration, i.e. depending on the process variable under consideration, a suitable deviation from the reference mean value can be established. If applicable, this can also take place by way of tests.

Furthermore, it is advantageous that as the qualitative model used in step c) a qualitative model of an injection-moulding process is used, in which correlations between the process variables and/or dependencies between the process variables e.g. in the form of rules, e.g. forming a set of rules, are contained.

Such a set of rules or such an accumulation of rules enables a reliable cause analysis and therefore the outputting of as small a number of possible causes as possible for the operator, even when for example a plurality of anomalies was established.

It is a further object of the invention to indicate a machine, in particular an injection-moulding machine, by which the method according to the invention for the automatic process monitoring and/or process diagnosis can be performed.

This problem is solved by a machine according to Claim 13, which is arranged and configured to carry out the method according to the invention. Such a machine is configured in particular as an injection-moulding machine.

It is also an object of the invention to indicate a set of machines, in particular a set of machines having injection-moulding machines, by which the method according to the invention for the automatic process monitoring and/or process diagnosis can be performed.

This problem is solved by a set of machines having the features of Claim 14. Such a set of machines is arranged and configured to perform/carry out the method according to the invention.

The invention is explained further below by way of example with the aid of the drawings. There are shown:

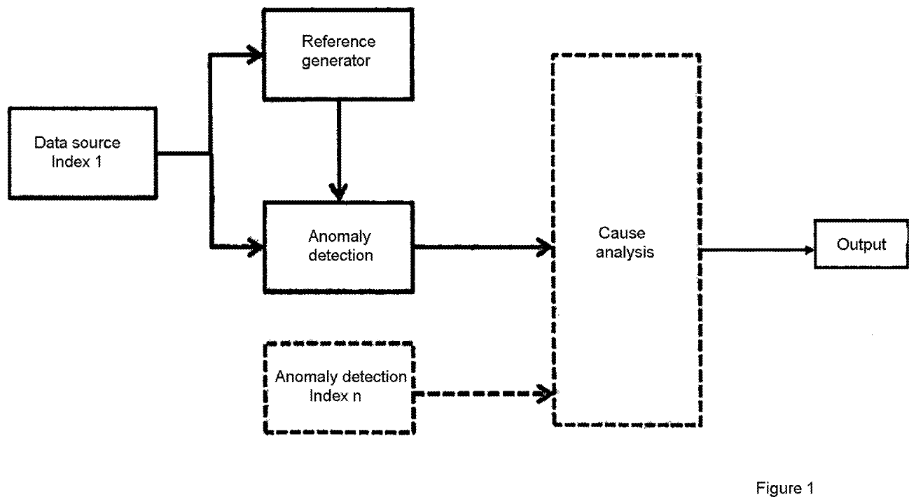

FIG. 1: a diagrammatic structure diagram of an anomaly detection for a specific index by the method according to the invention;

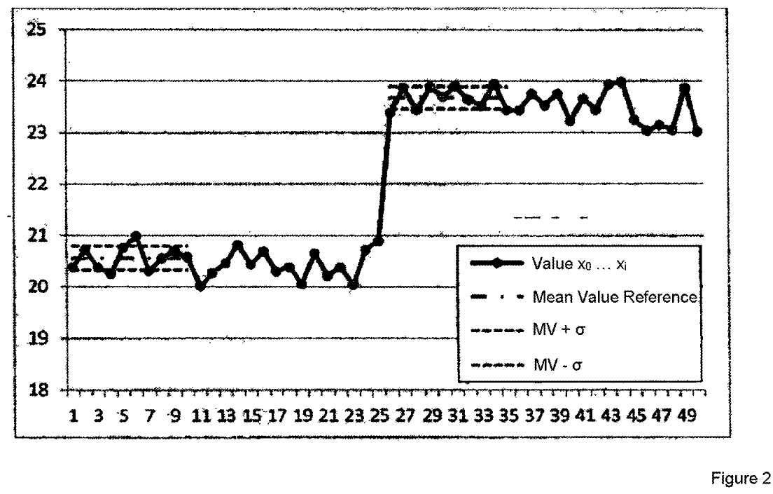

FIG. 2: a reference update after a jump in value, obtained by a method according to the invention;

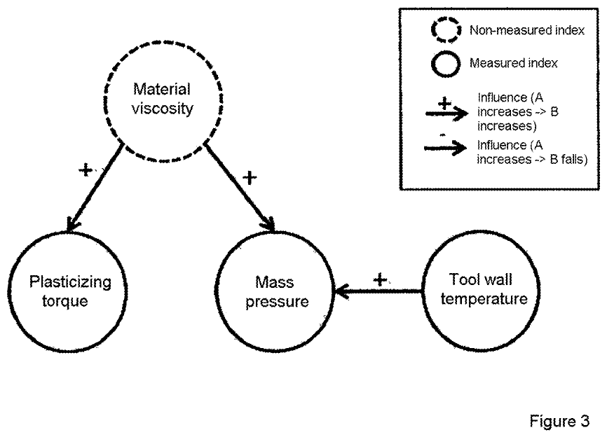

FIG. 3: exemplary correlations which can influence a process index, in particular in the example of a plastic injection-moulding process;

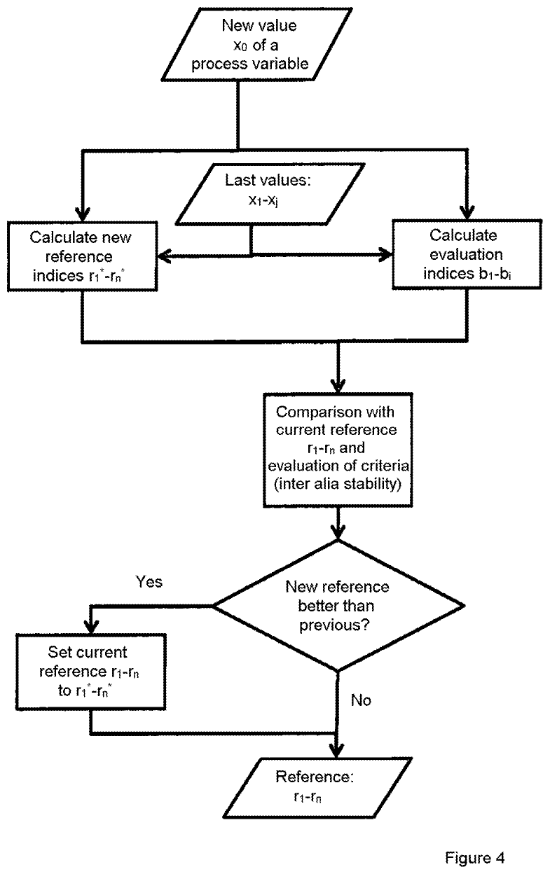

FIG. 4: a flow chart for determining a new reference in a reference generator used according to the invention;

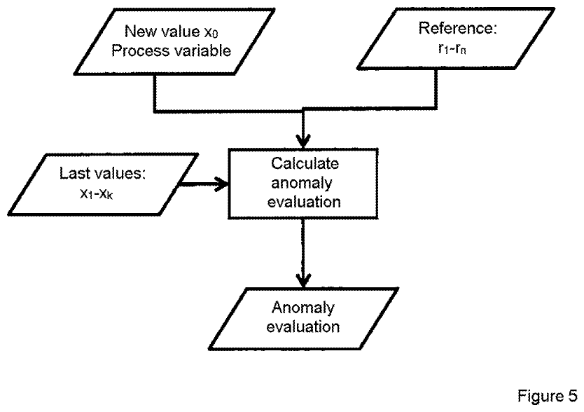

FIG. 5: a flow chart concerning an anomaly evaluation.

In FIG. 1 an anomaly detection, in particular a self-referencing anomaly detection according to step b) of the method according to the invention is illustrated in a highly schematized manner in the form of a structure diagram. By way of example, this is illustrated by means of a process variable (index 1) in a representative manner for any desired data source, in particular for process indices or process parameters or the measurement values thereof. Such a data source (index 1) delivers values x₀ . . . xⱼ of the process variable and is fed to a reference generator and to an anomaly detection. The reference generator contains a so-called current reference with current reference values rᵢ . . . rₙ and thereby the anomaly detection is able to establish an extraordinary value through comparison of the process variable (index 1) with the current reference values r₁ . . . rₙ and/or with past values x₁ . . . xₖ of the process variable. By way of example, it is established that a current value x₀ of the process variable (index 1) is characterized or evaluated as an anomaly when more than three reference standard deviations lie between the value x₀ of the process variable (index 1) which is to be assessed and the reference mean value. The reference mean value can be e.g. the mean value which is part of the current reference values r₁ . . . rₙ and/or calculated from the past values x₁ . . . xⱼ pf the process variable. In a preferred manner, this can concern an arithmetic mean value here. To obtain a reference, i.e. from current reference values r₁ . . . rₙ to replace a current reference through a future reference, reference is to be made to the description of FIG. 4 further below, by means of which the mode of operation of a reference generator is explained.

The reference generator is preferably present for each process variable (index), which is to be subjected to an anomaly detection. The reference generator is provided for example by the manufacturer of the machine performing the process with an initial reference, which represents first reference values r₁ . . . rₙ for the value x₀ of the process variable (index 1). Such a reference can consist of several values r₁ . . . rₙ, wherein for example n=10. The reference can be e.g. a standard deviation and/or the mean value and/or suchlike of a value progression of the process variable, i.e. the index 1. The values x₀ . . . xⱼ of the running process are read into the reference generator, wherein the reference is adapted to the process variable progression. The process variable progression here is a chronological progression of the measured values concerning the process variable/the index 1.

For adapting the reference here a window of e.g. j values is taken into consideration, wherein i is 10, for example. However, j can readily also assume values between 2 and 50 or 100, depending on how accurately a determination is to take place.

From these j values, provisional reference values rᵢ* . . . rₙ* and evaluation numbers b₁ . . . bᵢ are formed. The evaluation numbers b₁ . . . bᵢ serve e.g. for the evaluation of the quality or of the suitability of the provisional reference rᵢ* . . . rₙ* for the evaluation of the anomaly detection.

The evaluation numbers b₁ . . . bᵢ are, for example a section, e.g. an increase or a curve or another parameter of the succession of the corresponding j values. From the evaluation numbers b₁ . . . bᵢ, the current reference r₁ . . . rₙ and the provisional reference r₁* . . . rₙ*, on the basis of predetermined rules it is established and determined whether the current reference r₁ . . . rₙ is maintained or whether for example the environmental conditions have changed so that the provisional reference r₁* . . . rₙ* replaces the current reference r₁ . . . rₙ and is subsequently processed with the hitherto provisional, now current, reference (r₁*->r₁ . . . rₙ*->rₙ).

As an example, it is indicated in this respect that when e.g. the increase over j=10 values is smaller than a standard deviation from the current reference r₁ . . . rₙ and the provisional standard deviation is not greater than twice the current current reference r₁ . . . rₙ, the provisional reference r₁* . . . rₙ* is undertaken. If this is not the case, the provisional reference r₁* . . . rₙ* is rejected and the steps of value collection and of comparison start from the beginning. The process is continued until then with the unchanged current reference r₁ . . . rₙ.

A thus established, current reference r₁ . . . rₙ is passed on together with the past values x₁ . . . xₖ of the process variable to the anomaly detection, in order to establish an extraordinary value xₐ. Here, k is the window of values which are taken into consideration for the anomaly detection, wherein k e.g. is 20. When a value xₐ lies e.g. more than 3 reference standard deviations away from the reference mean value, then it is characterized as an anomaly. Nevertheless, instead of, or in addition to the previously described anomaly detection, in which there is the status anomaly (yes) or anomaly (no), supplying to a determination of anomaly probability can also take place. According to deviation from the corresponding current reference r₁ . . . rₙ a certain anomaly probability, e.g. 70 or 75% can be assigned to a specific extraordinary value xₐ. Such an anomaly characterization is then passed on to a cause analysis. Such an anomaly detection on the basis of values of different process variables takes place in an analogous manner to the anomaly detection explained above for further process variables in a parallel manner. The results of the anomaly detection are passed on respectively to the cause analysis.

In this way of proceeding, it can be that simultaneously or at short intervals a plurality of anomaly reports/anomaly characterizations/anomaly probabilities arise and therefore a plurality of reports/warnings/alarms are generated, because a plurality of process variables (indices 1) are processed in parallel and a process problem is mostly reflected not only in one single process variable, thus in a single index.

Such a plurality of reports/warnings/alarms is then channelled according to the invention through a cause analysis and prepared in a way which is easily understandable for a user/operator, or is passed on to systems (controls) which react in an automated manner. The cause analysis is configured as a so-called user-oriented combination of the anomaly reports and also of the subsequently explained stability reports and is necessary as such as essential to the invention. The operator/user or the person carrying out the process is mostly only interested in the causes of the process variable change, not so much in the individual process variable change as such.

The cause analysis takes place as a third step of the method according to the invention based on the knowledge concerning the correlations between the process variables, which is present in a specific process. This knowledge is often present in the experience of manufacturers of corresponding machines or in operators and is made available on one occasion in the form of a data loading process to the cause analysis and is stored there. The cause analysis uses this knowledge concerning the correlations between the process variables in order to draw conclusions regarding causes or respectively in order to make a targeted diagnosis or to deliver diagnosis recommendations.

For this, a qualitative model of the process, in particular of an injection moulding process is used, which contains correlations among the process variables. For this, extensive empirical values exist in specialist circles. These must be deposited in the cause analysis in particular in the form of “if-then relationships”.

Thus, e.g. in an injection-moulding process, it can be that an increased cylinder temperature leads to a more fluid plastic melt in the plasticizing cylinder and thereby to a lower pressure level in the injection process or respectively, in the case of pressure-regulated injecting, to a higher injection speed. Consequently, a plurality of detected anomalies for individual values, for example for a plastic melt which is too fluid in the plasticizing cylinder, a pressure level which is too low in the injection process, or am injection speed which is too high, is detected through the anomaly detection, wherein herefrom on the basis of corresponding empirical values the cause analysis can determine a single cause, namely that all three of these consequences can be traced back for example to an increased cylinder temperature. Such a set of rules can comprise a very large number of rules and is essentially dependent on the process which is to be assessed or respectively which is to be analysed in an automated manner. Such a rule set consisting of several rules brings about according to the invention that on its basis the diagnosis can be restricted extensively and, despite a plurality of detected anomalies, a diagnosis result matching these anomalies is delivered to the user/operator, which result enables a targeted intervention into the process. Thus, the user receives only the diagnosis report which is of interest to him and he can thus identify and remedy the cause of the changes and thereby the interference more quickly.

In FIG. 2 the step according to invention of the automated, self-referencing anomaly detection is presented by means of an example of a value x₀ which in the course of a plurality of cycles after a specific cycle (here e.g. cycle 25) performs a sudden value jump.

During the first 24 cycles the value x, which can be for example a pressure value, a viscosity or another value of an injection moulding process, therefore generally speaking a value of a process variable, is arranged within a value range of 20 to 21. A mean value reference (dot-and-dash line) is assigned to these values x and a mean value standard deviation (dashed line). Starting from cycle 25, a value jump upwards takes place into the range between 23 and 24, wherein in the further course starting from cycle 25 all values lie in this range.

Therefore, the value jump from cycle 25 to cycle 26 constitutes an anomaly which, however, is not a singular anomaly but rather constitutes an ongoing anomaly. Therefore, this does not concern an outlier, but rather—as already mentioned above—a value jump which, for example, if the value relates to a viscosity, can be traced back to a change in the injection speed of the injection-moulding machine.

The self-referencing anomaly detection is briefly explained in the following by means of FIG. 2. A batch manufacture of identical parts (serial parts) in piece-based process, such as e.g. in an injection-moulding machine, has the characteristic that a process is only stable when the process parameters for each cycle are without trend and without fluctuations which are too great. This characteristic can be used in order to automatically detect all deviating events, e.g. jumps, increases, outliers, decreases, overlapped oscillations and suchlike, and to evaluate them as anomalies and thus mark or evaluate them. For an automatic reference, the “natural” fluctuation is used here, wherein each value has such a natural, in particular unavoidable fluctuation, which are to be traced back for example to slightly fluctuating environmental conditions or a sensor noise. Such a natural fluctuation constitutes the best possible stability that is able to be achieved of the process parameter and is defined as such. As a measure for this, for example, the best achieved stability in the past can be used. This can be readily extrapolated in order to determine an accepted best achievable stability value for the future.

In the case of certain events, however, this reference does not necessarily have to re-formed, for example when environmental conditions and/or other essential process parameters have changed. Such changes can be e.g. a longer standstill of the machine or a tool change or a material change or a setting up of the machine in different environmental conditions. Through such an automation of the monitoring and an omitting of the manual threshold establishing, all the values of the process can be monitored. The system is therefore self-referencing or respectively self-learning and represents such anomalies in relation to a reference and decides independently regarding the use of a provisional reference which is possibly to be newly used compared to a hitherto current reference.

By means of FIG. 3, in connection with FIG. 1, the case of anomaly of an injection-moulding process is to be briefly explained. In the injection-moulding process, the plasticizing torque of the plasticizing screw can be measured for example with a simple sensor system. This constitutes a first value from a first data source (process variable: “plasticizing torque”). Also, the mass pressure of the plastic melt can be easily measured at a plurality of sites. The mass pressure is therefore a further index or respectively a further process variable. In a simple manner, the tool wall temperature is also a measurable process variable, and which is measured in the present example. All measured or measurable process variables are illustrated in FIG. 3 in closed circle symbols. Now it is also known that e.g. a material viscosity, which in the practical process is not so easy to measure, has effects on the plasticizing torque and also on the mass pressure, but not on the tool wall temperature.

If the anomaly detection modules of the individual indices (process variables) “plasticizing torque” and “mass pressure” establish a peculiarity for their values x₀ . . . xⱼ, but the “tool wall temperature” remains unremarkable, a computer system which is present can automatically make a conclusion that the material contained, but not measured, in the model (and/or its changed viscosity) must be the cause. This task falls to the cause analysis and is deposited there with a corresponding rule set. If, on the other hand, the parameters “tool wall temperature” and “mass pressure” show anomalies and the “plasticizing torque” does not, the cause will lie in the “tool wall temperature”. Such an if-then relationship is also deposited in the form of rules in the rule set of the cause analysis of the method according to the invention.

Through a corresponding systematic processing, the user receives according to the invention an indication directly of the cause, and does not first have to analyse, assess and evaluate the frequently present plurality of individual anomalies, in order to arrive at a corresponding cause result himself.

The method according to the invention can be carried out readily e.g. via an interface on an injection-moulding machine, wherein the interface sends characteristic values for each cycle to an external or also internal computer system e.g. of a processing unit/control on or in an injection-moulding machine. Such a computer system contains for example algorithms for the evaluation of different anomalies on the basis of the automatically formed reference. The patterns of resulting anomalies are interpreted by the second algorithm and are compiled to form a diagnosis. This diagnosis is then sent to the operator via the machine display or also via a network/internet to e.g. a mobile device such as a smartphone or a tablet computer and is displayed there if applicable. There, e.g. they can also be collected or also received over a greater number of machines and sorted, so that the method according to the invention for example with simultaneous occurrence of one and the same causes on a plurality of machines also enables a simplified cause analysis and cause research and maintenance in larger collections of machines, e.g. in a set of machines, in a simple manner.

In FIG. 4 a flow chart of a reference generator is represented schematically. Such a reference generator is assigned according to the invention to a plurality of process variables, in any case to the most important, which are necessary for an anomaly detection. The reference generator is subjected at the input side to a new value x₀. On the basis of the new value x₀, new reference indices r₁* . . . r_{n n}* belonging to this value x₀ are determined. Examples of such reference indices can be for example—as already mentioned—an arithmetic mean value or a standard deviation or further variables which are to be determined preferably arithmetically from the values x₀.

Parallel hereto, on the basis of the new value x₀ at least one evaluation index b₁ . . . bᵢ is calculated. An increase of the value progressions of the values x₀ . . . xⱼ for example can be as evaluation index.

Of course and particularly preferably the last values x₁ . . . xⱼ of the process variable, which lie in the past with respect to the newly inputted value x₀, enter into the calculation of the new reference indices r₁* . . . rₙ* and into the calculation of the evaluation indices b₁ . . . bᵢ.

With the new reference indices r₁* . . . rₙ* and the calculated evaluation indices b₁ . . . bᵢ a comparison with the current reference, formed from the or from a plurality of earlier past values x₁ . . . xⱼ, is carried out. Together with the comparison, an evaluation takes place of additional criteria which can take place for example by means of the evaluation indices b₁ . . . bᵢ. Such an additional criterion can be, for example, the stability of the process. Within the comparison of the calculated new reference indices rᵢ* . . . rₙ* with the present current reference r₁ . . . rₙ the question is answered as to whether the new reference is better than the previous (current) reference, in particular whether the new reference can better reflect or represent the process or respectively the progression or the progression which is to be expected of the corresponding process variable in future than the current reference r₁ . . . rₙ. If this is the case (yes) , the current reference r₁ . . . rₙ is replaced by the new reference r₁* . . . rₙ*, so that the new reference r₁* . . . rₙ* becomes the new current reference r₁ . . . rₙ.

If this is not the case, the old reference, therefore the old current refence r₁ . . . rₙ, is maintained.

The further process observation now takes place with the previous (current) reference r₁ . . . rₙ or with the renewed updated reference r₁ . . . rₙ.

The new value x₀ of the process variable in question—as illustrated schematically in FIG. 5—is delivered together with the valid, therefore the current reference or the currently replaced reference r₁ . . . rₙ to the anomaly evaluation. The new value x₀, through comparison with the corresponding valid reference values r₁ . . . rₙ and if applicable taking into consideration past values x₁ . . . xₖ within the anomaly evaluation is clearly characterized as an anomaly or is given a certain anomaly probability. Such an anomaly probability is assigned to the occurring deviating value x₀—in so far as it is one —, so that the value x₀ is either characterized as an anomaly or nor (0 or 1 decision), or the value x₀ of the corresponding process variable is given a certain anomaly probability (0 to 100%).

What is claimed is:

1. A method for the automatic process monitoring and/or process diagnosis of a piece-based process, comprising an injection-moulding process with the steps:
a) performing an automated reference finding in order to obtain reference values (r₁ . . . rₙ) from values (x₀ . . . xⱼ) of at least one process variable;
b) performing an anomaly detection for the detection of extraordinary values on the basis of the reference values (r₁ . . . rₙ) found in step (a); and
c) performing an automated cause analysis for determining causes of the anomaly and/or an automated fault diagnosis for diagnosis of process faults and process variable faults on a basis of a qualitative model of process relationships.

2. The method according to claim 1, wherein a result of the cause analysis and/or of the fault diagnosis is emitted at an output device or a result of the cause analysis/fault diagnosis is further processed in an automated manner, in at least one of a machine control and/or in a control of a set of machines and/or in a control for influencing a machine environment.

3. The method according to claim 1, wherein step a) comprises at least one or more of the sub-steps listed below:
a1) Evaluation of process values x₀ . . . xⱼ of process variables over several process cycles with regard to their suitability for use as reference through the calculation of evaluation indices b₁ . . . bᵢ and application of established rules, wherein as evaluation indices b₁ . . . bᵢ including the change trend of the values x₀ . . . xⱼ of the process variables, and/or fluctuations of the process variables are used or
a2) as reference of the automatic process monitoring and/or automatic process diagnosis, automatically determined reference values r₁ . . . rₙ are used, which reflect the ‘natural’ noise or uncertainty of the process variable, which each process variable has owing to environmental conditions and/or sensor noise, or
a3) when the provisional reference values r*₁ . . . r*ₙ formed from the process values x₀ . . . xⱼ of process variables on the basis of criteria and rules are better than the currently best found reference values r₁ . . . rₙ, these are set up as new best found reference values r₁ . . . rₙ or
a4) the reference values r₁ . . . rₙ of step a3) are used in order to automatically detect, evaluate and/or if applicable mark e.g. jumps, increases, outliers as anomalies or
a5) wherein the automatic reference, i.e. the reference values r₁ . . . rₙ in the case of predetermined events is compulsorily newly formed, wherein such predetermined events can be for example a longer standstill of the machine carrying out the process or a tool change.

4. The method according to claim 1, wherein a reference generator, which is equipped with an initial reference, is assigned to each process variable.

5. The method according to claim 4, wherein a reference consists of several reference values (r₁ . . . rₙ), wherein the reference values (r₁ . . . rₙ) reflect characteristics of a value progression of values (x₀ . . . xⱼ) of the process variable, including the standard deviation and/or the median of the value.

6. The method according to claim 4, wherein during the sequence of the process, the reference values (r₁ . . . rₙ) is adapted to the process variable progression which is determined by measurement, wherein for this a window of j values of the process variable is taken into consideration.

7. The method according to claim 6, wherein from the j values of the process variable (j) provisional reference values (r₁* . . . rₙ*) and evaluation numbers (b₁ . . . bᵢ) are formed.

8. The method according to claim 7, wherein the evaluation numbers (b₁ . . . bᵢ) are derivations, including the increase or the curve of the progression of the j values of the process variable over time.

9. The method according to claim 7, wherein from the evaluation numbers (b₁ . . . bᵢ) of the current reference values (r₁ . . . rₙ) and of the provisional reference values (r₁* . . . rₙ*) it is established by means of predetermined rules whether the current reference values (r₁ . . . rₙ) are maintained or in future the provisional reference values (r₁* . . . rₙ*) is used as new current reference values (r₁ . . . rₙ).

10. The method according to claim 1, wherein for each process variable an anomaly detection is provided, which uses the current reference values (r₁ . . . rₙ) and or past values of the process variable (x₁ . . . xₖ), in order to establish an extraordinary value, including an anomaly, or to evaluate it with regard to its probability.

11. The method according to claim 1, wherein a value of a process variable (x₀), which has a predetermined distance from current reference values (r₁ . . . rₙ), which lies more than three reference standard deviations away from the reference mean value, is characterized as “anomaly”.

12. The method according to claim 1, wherein the qualitative model used in step c) qualitative model of an injection-moulding process is used, in which relationships between the process variables and/or dependencies between the process variables are contained.

13. A machine, comprising an injection-moulding machine, which has a machine control and devices for the monitoring and/or measuring of process variables, wherein the machine is set up and configured to perform the method according to claim 1.

14. A set of machines, comprising a set of injection-moulding machines, which has a machine control and devices for the monitoring and/or measuring of process variables, wherein the set of machines is set up and configured to perform the method according to claim 1.
